(19) United States
(12) Patent Application Publication
(10) Pub. No.: US 2024/0242228 A1
(43) Pub. Date: Jul. 18, 2024

(54) CRYPTOCURRENCY WALLET

(71) Applicant: Ali Khan, New York, NY (US)

(72) Inventor: Ali Khan, New York, NY (US)

(21) Appl. No.: 18/602,738

(22) Filed: Mar. 12, 2024

Related U.S. Application Data
(60) Provisional application No. 63/438,680, filed on Jan. 12, 2023.

(51) Int. Cl. G06Q 20/42; G06Q 20/06; G06Q 20/36

(52) U.S. Cl. CPC G06Q 20/42; G06Q 20/065; G06Q 20/36

(57) ABSTRACT

A method includes generating a user interface that allows a user to select an action including at least one of rejecting the incoming cryptographic currency transaction, accepting the incoming cryptographic currency transaction, or holding the incoming cryptographic currency transaction. The method includes receiving, via the user interface, a selection by the user. The method also includes performing the action associated with the selection by the user.

### CROSS-REFERENCE TO RELATED APPLICATIONS

This application claims the benefit of priority of U.S. provisional application No. 63/438,680, filed Jan. 12, 2023, entitled “CRYPTOCURRENCY WALLET THAT SUPPORTS EVERY CRYPTOCURRENCY WHICH PROMPTS USERS TO ACCEPT OR REJECT ALL INCOMING TRANSACTIONS AND BLOCK SPECIFIC ADDRESSES FROM SENDING THEM CRYPTOCURRENCY AND WHICH USES CRYPTOCURRENCY ADDRESSES AS IDENTIFIERS FOR SENDING AND RECEIVING MESSAGES, ie LIKE TEXTING A PHONE NUMBER, BUT INSTEAD OF A PHONE NUMBER IT CAN USE ANY OF THE USER'S ADDRESSES TO RECEIVE CRYPTOCURRENCY AS A UNIQUE, IDENTIFYING NUMBER WITH THE ABILITY TO BLOCK SPECIFIC ADDRESSES FROM MESSAGING THEM,” the entire contents of which are herein incorporated by reference.

### FIELD

The present disclosure relates to cryptographic systems and processes and, more particularly, to cryptocurrency systems and processes.

### BACKGROUND

Cryptocurrency is growing in popularity. Cryptocurrency, however, can be inflexible in its usage.

As can be seen, there is a need for improved cryptocurrency systems and processes that addresses the above drawbacks.

### SUMMARY

In one aspect of the present disclosure, a method includes receiving an incoming cryptographic currency transaction. The method includes generating a user interface that allows a user to select an action including at least one of rejecting the incoming cryptographic currency transaction, accepting the incoming cryptographic currency transaction, or holding the incoming cryptographic currency transaction. The method includes receiving, via the user interface, a selection by the user. The method also includes performing the action associated with the selection by the user.

In another aspect of the present disclosure, a computer-readable medium stores instructions for causing one or more processors to perform a method. The method includes generating a user interface that allows a user to select an action including at least one of rejecting the incoming cryptographic currency transaction, accepting the incoming cryptographic currency transaction, or holding the incoming cryptographic currency transaction. The method includes receiving, via the user interface, a selection by the user. The method also includes performing the action associated with the selection by the user.

In another aspect of the present disclosure, a system includes one or more memory devices storing instructions and one or more processors. The one or more processors are configured to execute the instructions to perform a method. The method includes generating a user interface that allows a user to select an action including at least one of rejecting the incoming cryptographic currency transaction, accepting the incoming cryptographic currency transaction, or holding the incoming cryptographic currency transaction. The method includes receiving, via the user interface, a selection by the user. The method also includes performing the action associated with the selection by the user.

### BRIEF DESCRIPTION OF THE DRAWINGS

FIG. 1 is a block diagram of a network environment including a crypto wallet, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, cryptocurrency wallets do not have the ability to accept or reject someone or something sending you cryptocurrency. Additionally, cryptocurrency systems do not enable a user to message someone using any of their cryptocurrency addresses as a destination/receiving number. Further, cryptocurrency systems do not enable a user to block those messages if they are unwanted. Cryptocurrency systems do not allow near-field communication (NFC) technology as a transfer protocol for cryptocurrency and BLUETOOTH as a transfer protocol for cryptocurrency.

Broadly, an embodiment of the present disclosure provides cryptocurrency system and process that allows a user to accept or reject cryptocurrency being sent to you. The cryptocurrency system allows messaging using cryptocurrency addresses. The cryptocurrency system allows NFC and BLUETOOTH communications to send, receive and pay with cryptocurrency.

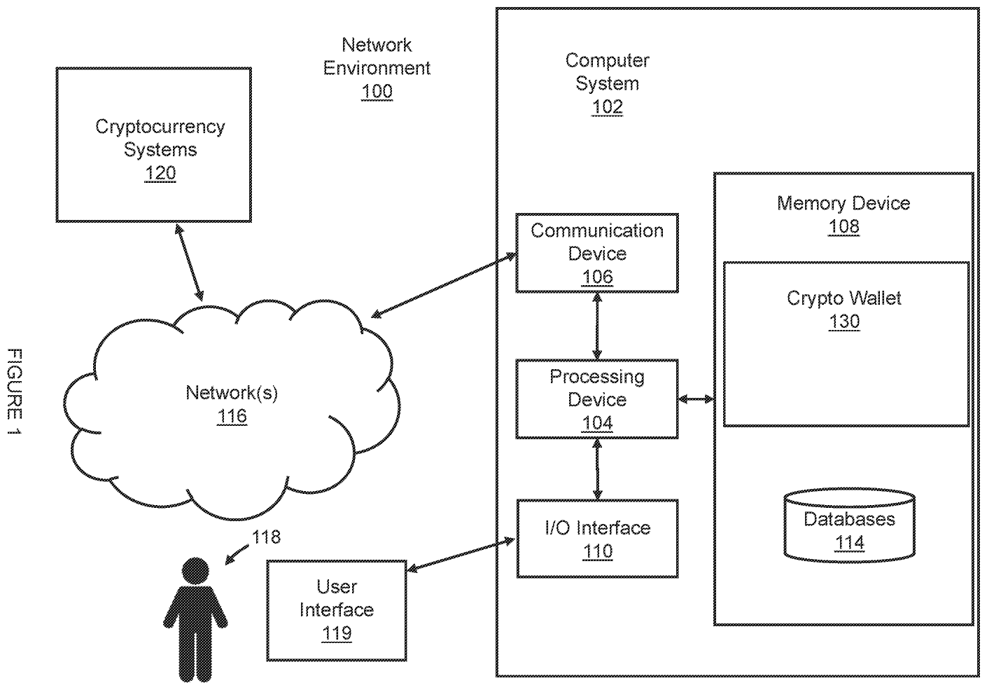

Referring now to FIG. 1, FIG. 1 illustrates a network environment 100, including a computer system 102 operating a crypto wallet 130, according to aspects of the present disclosure. While FIG. 1 illustrates examples of components of network environment 100, additional components can be added and existing components can be removed and/or modified.

As illustrated in FIG. 1, the computer system 102 can include one or more electronic devices such as a laptop computer, a desktop computer, a tablet computer, a smartphone, a thin client, and the like. The computer system 102 includes a processing device 104 coupled to a communication device 106. The processing device 104 is also coupled to a memory device 108, and an input/output (“I/O”) interface 110. In embodiments, the communication interface 104 enables the computer system 102 to communicate with other devices and systems via one or more networks 116. The computer system 102 can communicate one or more cryptocurrency systems 120.

According to the aspects of the present disclosure, the computer system 102 can store and execute the crypto wallet 130. The crypto wallet 130 enables the user 118, via a user interface 119, to perform various cryptocurrency transactions and processes with the cryptocurrency system 120. The crypto wallet 130 can include the necessary logic, instructions, and/or programming to perform the processes and methods described herein. The crypto wallet 130 can be written in any programming language. The crypto wallet 130 operates to generate and provide graphical user interfaces (GUIs) to the user 118, via the user interface 119, for example, menus, widgets, text, images, fields, etc. The GUIs generated by the crypto wallet 130 can be interactive.

The computer system 102 can include a user interface 119 for outputting information in a format perceptible by a user 118 and receiving input from the user 118. For example, the computer system 102 can communicate with the user interface 119 via the I/O interface 112. The user interface 119 can display graphical user interfaces (“GUIs”) generated by the computer system 102. The user interface 119 can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

In embodiments, the crypto wallet 130 is configured to accept or reject incoming cryptocurrency transactions. The crypto wallet 130 utilizes open source libraries to provide necessary functionality for the blockchain. For example, the crypto wallet 130 can import classes and functions from the library. Then, the crypto wallet 130 can set up a connection to the blockchain's application programming interface (API) or node provided by the cryptocurrency systems 120. The crypto wallet 130 can use the appropriate methods and functions from each library to wait for incoming transactions and prompt the user to accept or reject them, via one or more GUIs.

In embodiments, the crypto wallet 130 allows the user 118 to message other users using the cryptocurrency address. To implement the messaging feature using a messaging library or framework, the crypto wallet 130 installs a library or framework and imports the necessary classes and functions from the library or framework. Then, the crypto wallet 130 set up a connection to the messaging server, e.g., one operated by the cryptocurrency systems 120 or other third-party messaging service. The crypto wallet 130 uses the cryptocurrency wallet addresses as the identifiers for the users. The crypto wallet 130 can then send and receive messages via the network 116. The crypto wallet 130 can also include a feature that allows the user 118 to block specific cryptocurrency addresses from messaging.

In embodiments, the crypto wallet 130 can be configured to utilize NFC technology for cryptocurrency transactions. The crypto wallet 130 can import the necessary classes and functions from a library, e.g., PyQt5 library, to support NFC. To send cryptocurrency using NFC, the crypto wallet 130 can create a NFCNDEFMessage object that contains the data to send, and write it to an NFC tag using NFCNDEFWriterSession. The crypto wallet 130 use the beginSessionWithDelegate:queue:invalidateAfterFirstRead: method of the NFCNDEFWriter class to start the writing session, and the session:didDetectNDEFs: method of the NFCNDEFWriterSessionDelegate protocol to write the data to the tag. To receive cryptocurrency using NFC, the crypto wallet 130 can create a NFCNDEFReaderSession object and call its beginSession method to start the reading session, and implement the readerSession:didDetectNDEFs: method of the NFCNDEFReaderSessionDelegate protocol to process the data that is received.

In embodiments, the crypto wallet 130 can be configured to Apply BLUETOOTH technology to Send, Receive and Pay with Cryptocurrency. The crypto wallet 130 can import and store the necessary classes and functions from the CoreBluetooth framework. The crypto wallet 130 can create a CBPeripheralManager object and set its delegate to the crypto wallet 130 class. The crypto wallet 130 can implement the CBPeripheralManagerDelegate protocol in the crypto wallet 130 class, and implement the peripheralManagerDidUpdateState: method. The method can called when the Bluetooth state of the device changes and can be used to check if Bluetooth is enabled and ready to use. To send cryptocurrency using Bluetooth, the crypto wallet 130 can create a CBPeripheralManager object and call its startAdvertising: method, passing it a CBAdvertisementData object that contains the data to send. To receive cryptocurrency using Bluetooth, the crypto wallet 130 can create a CBCentralManager object and set its delegate to your class. Then, crypto wallet 130 can call scanForPeripherals:withServices:options: method, passing the service UUIDS that you are interested in, and implement the centralManager:didDiscover:advertisementData:rssi: method of the CBCentralManagerDelegate protocol to process the data that is received.

In embodiments, the crypto wallet 130 can support multiple types of cryptocurrency offered by the cryptocurrency system 120. To multiple cryptocurrencies, the crypto wallet 130 retrieve and store open-source libraries or frameworks that provide support for different cryptocurrencies, such as BitcoinJ for Bitcoin. The crypto wallet 130 can use Web3j to perform actions such as generating wallet addresses, creating and signing transactions, and querying blockchain data: The crypto wallet 130 can use RippleAPI to perform actions such as generating wallet addresses, creating and signing transactions, and querying blockchain data. The crypto wallet 130 can use LitecoinJ to perform actions such as generating wallet addresses, creating and signing transactions, and querying blockchain data. The crypto wallet 130 can use Cardano APIs to perform actions such as generating wallet addresses, creating and signing transactions, and querying blockchain data. The crypto wallet 130 can use Solana APIs to perform actions such as generating wallet addresses, creating and signing transactions, and querying blockchain data. The crypto wallet 130 can use Chia APIs to perform actions such as generating wallet addresses, creating and signing transactions, and querying blockchain data. The crypto wallet 130 can use EOS APIs to perform actions such as generating wallet addresses, creating and signing transactions, and querying blockchain data. For EOS does not have a single set of APIs that can be used to generate wallet addresses, create and sign transactions, and query the blockchain. EOS has a decentralized architecture with multiple blockchain. The crypto wallet 130 can use TRON Web3J APIs to perform actions such as generating wallet addresses, creating and signing transactions, and querying blockchain data. The crypto wallet 130 can use the Monero C++ library to perform actions such as generating wallet addresses, creating and signing transactions, and querying the Monero blockchain.

The crypto wallet 130 can use the Stellar Python library to perform actions such as generating wallet addresses, creating and signing transactions, and querying the Stellar blockchain. The crypto wallet 130 can use the NEO Python library to perform actions such as generating wallet addresses, creating and signing transactions, and querying the NEO blockchain. The crypto wallet 130 can use the Dogecoin Python library to perform actions such as generating wallet addresses, creating and signing transactions, and querying the Dogecoin blockchain. The crypto wallet 130 can use Web browser with Web3 capability taken from an Open Source Cryptocurrency Wallet Code.

The crypto wallet 130 is configured to generate GUIs that allow the user 118 to perform the process described herein. For example, the crypto wallet 130 can create a view controller that will be responsible for handling incoming transactions with three buttons labeled Accept, Reject and Hold. The crypto wallet 130 can create a toggle switch to silence the feature so users are not constantly bothered by notifications. The crypto wallet 130 can create a toggle switch to turn off the feature completely to receive all transactions as currently the norm.

In embodiments, the crypto wallet 130 can send, receive, accept, reject, hold, etc. cryptocurrency transactions regardless of how many other networks, proxies, third parties, etc. that are involved in the transaction. The crypto wallet 130 can also process request in any form such as entirety, partially, compressed, fragmented, flashed, represented in any way, shape or form meaning even if the currency itself is somehow being substituted through the use of any other form of data, avatar, etc. in addition to but not limited to similar or parallel networks, other networks that operate as any kind of representation of a blockchain network. The operation of the crypto wallet 130 applies for a command generated by the network (network for purposes of this explanation is any command on the network by either a computer, human, computer using a computer, human using a computer, human using a human to use a computer, a computer using a computer, a computer using a human who is then using another computer, animal to computer, computer to animal, animal to animal, animal to human to computer, computer to human to animal, etc.) is being influenced by another command on the network relating to data (in any way, shape or form) relating to (directly, indirectly, as a temporary or permanent hold, by proxy, third party, barter, exchange, refund, rebate, loan, interest, inventory, medical records, any industry, any use) cryptocurrency (in its most basic sense and definition is any kind of token, coin, or standard being used as a representative unit of something, either directly or indirectly). Any time, anyone or anything sends a piece of data on the blockchain and anytime, anyone or anything wants an option to respond in terms of receiving it or not, directly to itself or indirectly, or routed to or through something else including but not limited to being put on a “hold”, another computer system, forwarding out of the blockchain onto any network, including but not limited to being printed, exported, saved, given as a command or function, financial receipts, invoices, etc. is what is being invented. The Reverse is also true, the ability to send data and cryptocurrency as detailed above, with granting the recipient the option of accepting or rejecting said data is implicit and therefore protected. In addition, there will be a hold to deal with it later.

This logic is the same logic that applies to the messaging function in terms of being able to accept or reject data, however there is another innovation here where whether data is sent on or not on the blockchain BUT eventually having a blockchain address as a destination (no matter the mode of transport in between as is the case with cryptocurrency wallets on cell phones, tablets, etc. which use cellular networks, WiFi networks, public, private and virtual private and encrypted networks, etc. to an address on the blockchain) and no matter whether said destination is the final destination or a “pass through” in a larger network, which is another unique invention due to the multiple, different modes of transport. All of the above applies to transmission through NFC and Bluetooth technologies as well.

The crypto wallet 130 can support cryptocurrency that exists with password protection, that lists all of the cryptocurrencies and the amount of each cryptocurrency held by a user on the home screen with buttons for the following actions. The crypto wallet 130 can include a “Contacts” functionality that allows the user 118 to store cryptocurrency addresses attached to first and last names like a phone book); to block specific cryptocurrency addresses, and to accept or reject every receiving transaction. The crypto wallet 130 also include a “Message” functionality that allows the user 118 to message other users with this wallet, using the phone's internet connection using any of the other users' cryptocurrency receiving addresses as their identifiers i.e. like their phone numbers); and to block messages from specific cryptocurrency wallet addresses. The crypto wallet 130 includes cryptocurreny transaction features including send which lists all cryptocurrencies held by the user with the ability to: choose any cryptocurrency held by the user 118; choose addresses from the Contacts section; enter a custom cryptocurrency address; use the phone's camera to scan a cryptocurrency QR Code; receive cryptocurrency. For example, the crypto wallet 130 can generate a GUI with unique wallet addresses along with QR Codes for each of those addresses, to receive each type of Cryptocurrency that exists i.e. an address and QR Code for each type of Cryptocurrency like Bitcoin, Ethereum, Solana, etc.).

In embodiments, the crypto wallet 130 can include GUIs for performing transactions. For example, the GUIs can lists all of the cryptocurrency transactions of all cryptocurrencies sent and received with the ability to click on each transaction and to have it opened on the following website in the app's web browser. The crypto wallet 130 can include a Web Brower that supports Web3. The Web Browser can have a shortcut on its home screen for the following website: https://essexexchange.nyc, be written in Objective-C. The crypto wallet 130 can include a wallet architecture that has an opening Screen Prompts A Password but also utilizes biometric authentication, e.g., Apple Face ID, and a home screen has buttons labeled with the functionality described above.

In embodiments, the crypto wallet 130 can be configured to utilize blockchain technology in a variety of applications. Blockchain technology is extremely versatile due to the nature of decentralization and the ability to view every transaction on the blockchain. Now, this has massive implications for nearly every industry imaginable. What blockchain technology essentially does is make the movement of anything trackable. Let's take fashion inventory for example. One can track a sweater that was made in Phillipines, from the moment it was completed being sewn to when and where it was sold and every other place in between. This is possible because the sweater becomes a unit of data on the blockchain. Now whoever comes into possession of this sweater will enter it and their location as a transaction on the blockchain. So if there is any issue of theft, defects, mishandling, etc. of any kind, one can pinpoint exactly where the sweater has been and inquire about whether something happened to that particular box it was in while being shipped, if there was a problem during transport or if the factory had some kind of mishap or technical difficulties. The beauty of blockchain technology and transactions is that they are public (either to the entire general population or a specific population [private blockchain, but still completely transparent to everyone in a particular group]), like the employees of a clothing label for example. Now, this has far reaching implications for any and every industry. Medical records, which are protected under extremely strict confidentiality laws, can be transferred from one section of a healthcare facility to another or to a completely different facility altogether. All the while, there is no mystery as to where the records were on their entire journey from point A to point B. Everyone who has handled them has a unique identifier (cryptocurrency address) and they have checked in when they have received them (made a transaction) which is available for all the healthcare workers involved to see (on the Public Ledger).

The memory device 108 can also include a database 114 that stores information and data associated with the process and methods described herein. The database 114 can store ***. The database 114 can be any type of database, for example, a hierarchical database, a network database, an object-oriented database, a relational database, a non-relational database, an operational database, and the like.

The processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the computer system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the computer system 102 can include multiple memory devices 108, whether the same type or different types.

The communication device 104 enables the computer system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The computer system 102 can communicate with one or more network resources via the network 116. The one or more network resources can include external databases, social media platforms, search engines, file servers, web servers, or any type of computerized resource that can communicate with the computer system 102 via the network 116.

In embodiments, the components and functionality of the computer system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the computer system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Below is an example of how you can use BitcoinJ to generate a new Bitcoin wallet address and QR code in the crypto wallet 130

import BitcoinJ
// Generate a new Bitcoin wallet address
let networkParameters = TestNet3Params.self
let wallet = Wallet(network: networkParameters)
let address = wallet.currentReceiveAddress
// Generate a QR code for the wallet address
let qrCode = QRCode(address)
let qrCodelmage = qrCode?.image

Below is an example of how you can use Web3j to send a transaction to the cyrpto wallet 130:

```
  import Web3j
  // Set the Ethereum node URL and the wallet address to send the
transaction to
  let nodeUrl = “https://mainnet.infura.io/v3/your-api-key”
  let walletAddress = “0x1234567890ABCDEF”
  // Set the amount of Ether to send and the private key for signing the
transaction
  let amount = BigInt(“0.1”)
  let privateKey = “your-private-key”
  // Create a Web3j instance
  let web3j = Web3j(nodeUrl: nodeUrl)
  // Create a transaction object
  let  transaction  =  EthSendTransaction(to:
EthereumAddress(walletAddress), value: amount)
  // Sign the transaction with the private key
  let signedTransaction = try transaction.sign(privateKey: privateKey,
chainId: BigInt(1))
  // Send the signed transaction to the Ethereum network
  let result = try web3j.ethSendRawTransaction(signedTransaction).send( )
```

Below are some examples of how you can use BitcoinJ to perform actions such as generating wallet addresses, creating and signing transactions, and querying blockchain data:

```
  To generate a new Bitcoin wallet address:
  import BitcoinJ
  // Generate a new Bitcoin wallet address
  let networkParameters = TestNet3Params.self
  let wallet = Wallet(network: networkParameters)
  let address = wallet.currentReceiveAddress
  To create and sign a Bitcoin transaction:
  import BitcoinJ
  // Set the network parameters and the wallet to use for the transaction
  let networkParameters = TestNet3Params.self
  let wallet = Wallet(network: networkParameters)
  // Set the address to send the transaction to and the amount to send
  let toAddress = “mnYJZVzBh5f5q5MnX5Z5W5Z5G5Q5R5L5”
  let amount = Coin.parseCoin(“0.01”)
  // Create a transaction object
  let transaction = wallet.createSend(to: toAddress, amount: amount)
  // Sign the transaction
  wallet.sign Transaction(transaction)
  // Send the transaction to the network
  try wallet.sendCoins(transaction)
  To query the Bitcoin blockchain:
  import BitcoinJ
  // Set the network parameters and the wallet to use for the query
  let networkParameters = TestNet3Params.self
  let wallet = Wallet(network: networkParameters)
  // Set the address to query
  let address = “mnYJZVzBh5f5q5MnX5Z5W5Z5G5Q5R5L5”
  // Create a blockchain object
  let blockchain = wallet.peerGroup.blockChain
  // Query the blockchain for the address's balance
  let balance = blockchain.getBalanceFuture(address, confirmations:
0).get( ).
```

To store cryptocurrency addresses and related information such as first and last names in an SQLite database, you will need to do the following:

```
  1. Install the SQLite Python library:
    pip install pysqlite
  2. Create a connection to the database:
    import sqlite3
    # Connect to the
    conn = sqlite3.connect(“wallet.db”)
  3. Create a table to store the cryptocurrency addresses and related
information:
    # Create a table to store the cryptocurrency addresses and
  related information
    conn.execute(
    “CREATE TABLE addresses (id INTEGER PRIMARY KEY,
  first_name TEXT, last_name TEXT, address TEXT)”
  )
  4. Insert cryptocurrency addresses and related information into the table:
    # Insert a new cryptocurrency address and related information
  into the table
    conn.execute(
    “INSERT INTO addresses (first_name, last_name, address)
  VALUES (?, ?, ?)”,
    (“John”, “Doe”, “1A1zP1eP5QGefi2DMPTfTL5SLmv7DivfNa”),
  )
    conn.commit( )
  5. Query the database for cryptocurrency addresses and related
information:
    # Query the database for all cryptocurrency addresses and
  related information
    cursor = conn.execute(“SELECT * FROM addresses”)
    for row in cursor:
    print(row)
  6. Close the connection to the database:
  # Close the connection to the database
  conn.close( )
```

To implement the messaging feature using a messaging library or framework like XMPP or Socket.IO, you will need to do the following:

```
  1. Install the library or framework:
    For example, to install the Socket.IO Python library:
    pip install python-socketio
  2. Import the necessary classes and functions from the library or
framework:
    For example, to import the necessary classes and functions from
  the Socket.IO library:
    import socketio
    sio = socketio.Client( )
  3. Set up a connection to the messaging server:
    # Connect to the messaging server
    sio.connect(“http://localhost:3000”)
  4. Use the cryptocurrency wallet addresses as the identifiers for the users:
    # Set the user's cryptocurrency wallet address as their identifier
    sio.emit(“identify”,  {“address”:
  “1A1zP1eP5QGefi2DMPTfTL5SLmv7DivfNa”})
  5. Use the phone's internet connection to send and receive messages:
    # Send a message to another user
    sio.emit(“send_message”,  {“to”:
  “1B1zP1eP5QGefi2DMPTfTL5SLmv7DivfNa”, “message”: “Hello!”})
    # Receive a message from another user
  @sio.on(“message_received”)
    def on_message_received(data):
    print(f“Received message from {data[‘from’]}: {data[‘message’]}”)
  6. Disconnect from the messaging server when necessary:
    # Disconnect from the messaging server
    sio.disconnect( )
```

To use open source libraries to accept or reject incoming transactions from every blockchain, you will need to do the following:

1. Find open source libraries that provide the necessary functionality for

each blockchain. For example, you can use the following libraries:

| | | |
|---|---|---|
| • | | python-bitcoinlib for Bitcoin |
| | • | web3j for Ethereum |
| • | | ripple-lib for Ripple |
| • | | litecoinj for Litecoin |
| • | | cardano-sl for Cardano |
| • | | solana-sdk for Solana |
| • | | eosjs for EOS |
| • | | tron-api for TRON |
| • | | stellar-sdk for Stellar |
| | | neo-python for NEO |
| | | dogecoin for Dogecoin |

Install the necessary libraries: For example, to install the web3j library for Ethereum:
pip install web3j
3. Import the necessary classes and functions from each library:

For example, to import the necessary classes and functions from the web3j

library:

from web3 import Web3
web3 = Web3(Web3.HTTPProvider(“http://localhost:8545”))

4. Set up a connection to the blockchain's API or node:

```
  For example, to connect to the Ethereum blockchain using the
web3j library:
  # Connect to the Ethereum blockchain
  web3.eth.defaultAccount = web3.eth.accounts[0]
```

5. Use the appropriate methods and functions from each library to wait for incoming
transactions and prompt the user to accept or reject them.

```
  For example, to wait for incoming transactions and prompt the
user to accept or reject them using the web3j library for Ethereum:
  # Wait for an incoming transaction
  tx_hash = web3.eth.waitForTransaction Receipt(tx_hash
```

SAMPLE code to demonstrate how this could be done using the python-bitcoinlib library:

from bitcoinlib.services import Service
# Connect to a Bitcoin node
service = Service(host=‘localhost’)
# Get a list of addresses that you want to accept transactions from
accepted_addresses = [‘1BvBMSEYstWetqTFn5Au4m4GFg7xJaNVN2’,
‘1JztLWos5K7LsqW5E78EYS4S5mWxJ03fN6’]
# Listen for incoming transactions
for tx in service.blockchain.transactions( ):
# Check if the transaction is from an accepted address
for vin in tx.vins:
if vin[‘address’] in accepted_addresses:
# Process the transaction
print(‘Accepted transaction:’, tx.txid)
else:
# Ignore the transaction
print(‘Rejected transaction:’, tx.txid)

To use libraries to accept, reject or hold incoming transactions from python-bitcoinlib for Bitcoin

To use the python-bitcoinlib library to accept, reject, or hold incoming transactions for Bitcoin, you would first need to install the library by running the following command in your terminal:

pip install python-bitcoinlib

Once you have installed the library, you can use the following code to connect to the Bitcoin network and receive incoming transactions:

from bitcoin import *
# Connect to the Bitcoin network
conn = blockchain. BlockchainConnection( )
# Get the latest block
block = conn.get_latest_block( )
# Loop through all the transactions in the latest block
for tx in block.transactions:
# Check if the transaction is an incoming transaction
if tx.inputs[0].address == YOUR_BITCOIN_ADDRESS:
# Check if the transaction is above a certain amount
if tx.outputs[0].value > MINIMUM_AMOUNT:
# Accept the transaction
print(“Accepting transaction”)
else:
# Reject the transaction
print(“Rejecting transaction”)
else:
# Hold the transaction
print(“Holding transaction”)

This code connects to the Bitcoin network using the blockchain.BlockchainConnection class and retrieves the latest block using the get_latest_block method. It then loops through all the transactions in the latest block and checks if the first input of the transaction is equal to your Bitcoin address. If it is, it checks if the value of the first output is above a certain amount. If it is, it accepts the transaction, otherwise, it rejects the transaction. If the first input is not equal to your address, it holds the transaction.

To accept, reject, or hold incoming transactions using the python-bitcoinlib library for Bitcoin, you can write code to interact with the Bitcoin network through the library. Here's a basic outline of the steps you would need to follow:
1. Install python-bitcoinlib: Before you can start using the library, you'll need to install it on your system. You can do this by running the following command in your terminal or command prompt:

pip install python-bitcoinlib

2. Connect to the Bitcoin network: To interact with the Bitcoin network, you need to connect to a node that is running the Bitcoin software. You can do this by creating an instance of the BitcoinRPC class and passing it the URL of the node you want to connect to.
3. Retrieve incoming transactions: To receive incoming transactions, you need to retrieve them from the node you're connected to. You can do this by calling the getrawmempool method, which returns a list of all the transactions in the node's memory pool (the pool of unconfirmed transactions).
4. Filter transactions: From the list of transactions, you can filter the ones that are relevant to you by checking the transaction outputs (the addresses to which the bitcoins are sent) against the addresses in your wallet.
5. Accept, reject, or hold transactions: Once you have filtered the transactions, you can use the sendrawtransaction method to accept them, or simply ignore them if you want to reject them. If you want to hold a transaction, you can simply not broadcast it to the network.

To implement a UI prompt for the accept, reject, or hold incoming transaction functionality in Python, you can use a GUI library such as Tkinter or PyQt. Here's a high-level overview of how you can implement it:
1. Create a GUI window: Use the Tkinter or PyQt library to create a GUI window for the prompt.
2. Add a label: Add a label to the window to display a message asking the user to accept, reject, or hold the incoming transaction.
3. Add buttons: Add three buttons to the window, labeled “Accept”, “Reject”, and “Hold”, to allow the user to select their desired action.
4. Add event handlers: Add event handlers to the buttons to handle the user's selections. For example, when the “Accept” button is clicked, the corresponding transaction should be accepted.
5. Call the corresponding function: Call the appropriate function from the python-bitcoinlib library to accept, reject, or hold the transaction based on the user's selection.
to use open source libraries to accept, reject or hold all incoming transactions from ripple-lib for Ripple in python

To use the ripple-lib library to implement the functionality to accept, reject, or hold incoming transactions in Python, you would need to perform the following steps:

```
  1. Install the ripple-lib library. You can do this using the pip package
manager with the following command:
  pip install ripple-lib
  2. Connect to the Ripple network using the ripple-lib library. You can do
this by creating an instance of the WebSocket class and connecting to the Ripple
WebSocket API endpoint.
  from ripple_lib import WebSocket
  # Connect to the Ripple WebSocket API endpoint
  ws = WebSocket(‘wss://s.altnet.rippletest.net:51233’)
  3. Subscribe to the events that you're interested in, such as incoming
transactions. You can do this by calling the ws.subscribe method and passing in the
relevant event type.
  # Subscribe to incoming transactions
  ws.subscribe(event=‘transactions’, callback=handle_transaction)
  4. Implement the handle_transaction function to handle incoming
transactions. This function should prompt the user to accept, reject, or hold the
transaction using a UI prompt with three buttons labeled “Accept”, “Reject”, and
“Hold”.
  def handle_transaction(transaction):
  # Prompt the user to accept, reject, or hold the transaction
  # . . .
  . . .
  5. Start the WebSocket connection and wait for incoming transactions.
  # Start the WebSocket connection
  ws.start( )
  # Wait for incoming transactions
  # . . .
  . . .
```

To add a feature to hold a transaction in a cryptocurrency wallet, you would need to modify the code that handles incoming transactions. The specific steps would depend on the implementation of the wallet and the underlying cryptocurrency libraries being used.

Here is a high-level overview of the steps you would need to take:
1. Determine the point in the code where incoming transactions are detected.
2. Modify the code to allow the user to hold an incoming transaction instead of automatically accepting or rejecting it. You could do this by adding a new state to the transaction object (e.g. “held”), or by adding a new field to the database that tracks the status of each transaction.
3. Add a user interface that allows the user to view and manage held transactions. This could be a new screen in the app that lists all held transactions, with options to accept, reject, or continue holding each one.
4. Update the code that handles outgoing transactions to take into account the status of held transactions. For example, if a user attempts to send funds that are part of a held transaction, the app should prompt the user to resolve the hold before proceeding with the send.
5. Test your changes thoroughly to ensure that the hold feature works as expected and does not introduce any unintended consequences.

To make a user interface (UI) prompt to accept or reject an incoming transaction, you will need to do the following:
1. Create a UI element, such as a button or a dialog box, that allows the user to make a choice.
2. When an incoming transaction is detected, display the UI element and provide the necessary information about the transaction, such as the transaction amount, the sender's address, and any other relevant details.
3. Use an event listener or callback function to handle the user's response. For example, if the user clicks an “Accept” button, you can execute the code to accept the transaction. If the user clicks a “Reject” button, you can execute the code to reject the transaction.

To use the Solana SDK library to accept or reject incoming transactions, you would need to implement the following steps:
1. Install the solana-sdk library by running pip install solana-sdk in your terminal or command prompt.
2. Import the necessary modules from the solana-sdk library in your Python script, such as solana.rpc and solana.transaction.
3. Connect to a Solana cluster using the solana.rpc.Client class. You can do this by creating an instance of the class and passing in the URL of a Solana cluster node.
4. Use the solana.transaction. Transaction class to create transactions. You can use the methods of this class to set the transaction parameters, such as the amount, the source address, and the destination address.
5. Use the send_transaction method of the solana.rpc.Client class to send the transactions to the Solana network.
6. Use the get_transaction method of the solana.rpc.Client class to retrieve the details of a transaction, including its status. You can use this information to determine whether to accept or reject the transaction.
7. Implement the UI prompt for accepting, rejecting or holding the incoming transaction. You can use a library like tkinter to create the prompt and display the buttons labeled “accept”, “reject”, and “hold”. When the user clicks on one of the buttons, you can use the logic you implemented in step 6 to decide whether to accept, reject, or hold the transaction.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A system, comprising:
one or memory devices storing a crypto wallet that includes instructions; and
one or more processing devices configured to execute the instruction to perform a method comprising:
receiving an incoming cryptographic currency transaction;
generating a user interface that allows a user to select an action comprising at least one of rejecting the incoming cryptographic currency transaction, accepting the incoming cryptographic currency transaction, or holding the incoming cryptographic currency transaction;
receiving, via the user interface, a selection by the user; and
performing the action associated with the selection by the user.

2. The system of claim 1 wherein the one or more processing devices are configured to execute the instruction to perform the method further comprising:
receive a request to perform a new cryptographic currency transaction via a wireless communication protocol; and
executing the new cryptographic currency transaction via a wireless communication protocol.
